(19) United States
(12) Patent Application Publication
(10) Pub. No.: US 2025/0133539 A1
(43) Pub. Date: Apr. 24, 2025

(54) METHOD AND APPARATUS FOR CONTROLLING ALL-IN-ONE RADIO EQUIPMENT BASED O-RAN

(71) Applicant: HFR Networks Inc., Richardson, TX (US)

(72) Inventors: Kwangho CHO, Allen, TX (US); Youngsu Chae, Plano, TX (US)

(21) Appl. No.: 18/918,477

(22) Filed: Oct. 17, 2024

Related U.S. Application Data
(63) Continuation of application No. 63/545,046, filed on Oct. 20, 2023.

(51) Int. Cl. H04W 72/04

(52) U.S. Cl. CPC H04W 72/04

(57) ABSTRACT

A method and an apparatus for controlling all-in-one radio equipment based on O-RAN are provided.

### CROSS-REFERENCE TO RELATED APPLICATIONS

This application claims priority from U.S. Patent Application No. 63/545,046, filed on Oct. 20, 2023, which is hereby incorporated by reference for all purposes as if fully set forth herein.

### TECHNICAL FIELD

The present disclosure relates to a method and an apparatus for controlling all-in-one radio equipment based on O-RAN.

### BACKGROUND OF THE INVENTION

The content described below merely provides background information related to the present embodiment, and does not constitute the related art.

As the 5th-generation (5G) network has been developed, this technology has been used not only in a public network but also in a private network. Accordingly, companies are allowed to build their own 5G networks and use a wireless service network required for the companies.

The 5G network adopts an Open Radio Access Network (ORAN) proposed by the Open RAN Alliance. In particular, the ORAN proposes a Fronthaul Multiplexer (FHM) technology that supports shared cell functions for building a Radio Access Network (RAN) inside a building.

FIGS. 1A, 1B, and 1C are diagrams illustrating several examples where components of the ORAN are respectively located in an on-premise system and a cloud system.

### DISCUSSION

In a private 5G network based on the ORAN, as shown in FIG. 1A, all components may be located in the on-premise system, or as shown in FIG. 1B, a 5G Core and Service Management Orchestration (SMO) may be located in the cloud system, and the RAN including a Central Unit (CU) and a Distribution Unit (DU) may be located in the on-premise system.

In addition, in FIG. 1C, unlike FIG. 1B, a configuration may be implemented so that the FHM is inserted between the DU and a Radio Unit (RU) and the FHM is located in the on-premise system. In this case, during a downlink, the FHM copies one radio cell data received from the DU to a plurality of ORAN Radio Units (O-RUs), and conversely, during an uplink, data received from the plurality of RUs is merged and transmitted to the DU. In this manner, all RUs connected to one FHM may be configured to share a frequency band in the same radio cell and to provide a wireless communication service.

FIGS. 2A, 2B, and 2C are diagrams in which a hardware location of each component of the ORAN is illustrated for each case.

As illustrated in FIG. 2A, respective modules of the ORAN may be virtualized and operated in mutually different servers, and as illustrated in FIG. 2B, the CU and the DU may be mounted and operated on a single server. As illustrated in FIG. 2C, the CU may be mounted and virtualized on a single server, and the DU and the RU may be implemented as single hardware.

When the FHM is implemented as in FIGS. 2A and 2B, one FHM has a shared cell support function that allows one radio cell to have a plurality of Component Carriers associated with the plurality of RUs.

FIG. 3A is a diagram illustrating a data flow in the FHM during the downlink, and FIG. 3B is a diagram illustrating a data flow in the FHM during the uplink.

As illustrated in FIGS. 3A and 3B, one FHM (320) may be located between one DU (310) and a plurality of RUs (331, 332, and 333) to provide a shared cell function.

In this case, the FHM (320) provides a first function (321) for copying and transmitting one cell data received from the DU (310) to the plurality of RUs (331, 332, and 333) during the downlink as illustrated in FIG. 3A, and a second function (312) for merging the cell data received from the plurality of RUs (331, 332, and 333) into one data set and transmitting the one data set to the DU (310) during the uplink as illustrated in FIG. 3B.

In this case, the FHM may form the plurality of RUs into one group to eliminate interference or noise between the RUs, and may provide selective copying for the cell data from the DU within the same group to any one RU group and selective reception of the DU for the cell data from one RU group. In this manner, the FHM may provide the shared cell function between the grouped RUs. For these selective copying and selective reception operations, while repeating the downlink and the uplink, the FHM repeats a copy function (311) for copying the cell data received from the DU or a CU (not illustrated), a decompression function (323) for decompressing a plurality of the cell data from the plurality of RUs (331, 332, and 333), a merging function (322) for merging the plurality of cell data into one merged data, and a function (324) for compressing the merged data.

A mobile communication service provider may be configured to use a specialized RAN facility as in a configuration illustrated in FIGS. 1A to 3B so that RAN-related specialized personnel can install, manage, and operate the specialized RAN facility in accordance with a service purpose of the mobile communication service provider.

However, in a case of the private network, due to a lack of highly trained personnel, it is difficult to install and operate the private network with a complex configuration system such as configuration systems of equipment owned by the mobile communication service provider. In addition, in terms of price, there is a need to build the RAN at an economical price, unlike the mobile communication service provider.

### SUMMARY

The present disclosure mainly aims to provide a method and an apparatus for controlling all-in-one radio equipment based on O-RAN.

Aspects to be achieved by the present disclosure are not limited to the above-described aspects, and other aspects which are not described herein will be clearly understood by those skilled in the art from the description below.

An embodiment of the present disclosure provides an apparatus for controlling wireless equipment, comprising: a downlink DU that receives downlink data and RU group identification information from a network function, converts the downlink data into first IQ data, compresses the first IQ data, generates first compressed IQ data, and transmits a first message including the first compressed IQ data and the RU group identification information to an FHM unit; the FHM unit that receives the first message from the downlink DU, transmits each of the first compressed IQ data to at least one RU corresponding to the RU group identification information, receives each second compressed IQ data from the at least one RU, decompresses each of the second compressed IQ data, generates each second original IQ data, merges each of the second original IQ data, generates merged IQ data, and transmits a merged message including the merged IQ data to an uplink DU; and the uplink DU that acquires the merged message from the FHM unit, generates uplink data from the merged IQ data, and transmits the uplink data to the network function.

Another embodiment of the present disclosure provides a method for controlling wireless equipment in which an apparatus including a downlink DU, an FHM unit, and an uplink DU control wireless equipment, a method comprising: a process in which the downlink DU receives downlink data and RU group identification information from a network function, converts the downlink data into first IQ data, compresses the first IQ data, generates first compressed IQ data, and transmits a first message including the first compressed IQ data and the RU group identification information to the FHM unit; a process in which the FHM unit receives the first message from the downlink DU, transmits each of the first compressed IQ data to at least one RU corresponding to the RU group identification information, receives each second compressed IQ data from the at least one RU, decompresses each of the second compressed IQ data, generates each second original IQ data, merges each of the second original IQ data, generates merged IQ data, and transmits a merged message including the merged IQ data to the uplink DU; and a process in which the uplink DU acquires the merged message from the FHM unit, generates uplink data from the merged IQ data, and transmits the uplink data to the network function.

According to an embodiment of the present disclosure, all functions required for building a 5G network may be integrated into a single server, and corporate customers having relatively little 5G-related experience and technology may easily build their own private 5G network.

In addition, the private 5G network may be built in such a manner that components such as routers, some functions of a 5G Core, CUs, and DUs are installed as software and virtualized. Accordingly, each of the components of the private 5G network may be freely disposed, and resources may be flexibly allocated in response to an increase in traffic capacity or subscribers.

In addition, a 5G network environment which was previously divided into a plurality of hardware, that is, servers, routers, and FHMs, is integrated into a single server, and the private 5G network is built. Accordingly, cables between the plurality of hardware forming the private 5G network may be significantly reduced to provide an economical private 5G network.

In addition, the private 5G network may be simply installed, an installation space may be saved, power consumption may be reduced, and the number of connection points where a failure occurs in the private 5G network may be reduced.

In addition, an FHM function may be implemented as an internal function of the server rather than a separate box so that direct access to the FHM is allowed from the DU. Accordingly, since unnecessary compression and decompression of data exchanged with the DU are not repeated, latency of data transmission may be reduced in the private 5G network, and computing resources may be saved.

Advantageous effects of the present disclosure are not limited to the above-described advantageous effects, and other advantageous effects which are not described herein will be clearly understood by those skilled in the art from the description below.

### BRIEF DESCRIPTION OF THE DRAWINGS

FIGS. 1A, 1B, and 1C are diagrams illustrating several examples where components of an ORAN are respectively located in an on-premise system and a cloud system.

FIGS. 2A, 2B, and 2C are diagrams in which a hardware location of each component of the ORAN is illustrated for each case.

FIG. 3A is a diagram illustrating a data flow in an FHM during a downlink, and FIG. 3B is a diagram illustrating a data flow in the FHM during an uplink.

FIG. 4 is a block diagram illustrating a configuration of a wireless equipment control apparatus (400) according to one embodiment of the present disclosure.

FIG. 5 is a diagram illustrating a state where a downlink DU (411) and an uplink DU (412) are implemented on a wireless network device (410) and an FHM unit (420) is connected to a wireless network device (410).

FIG. 6 is a diagram illustrating a structure and each RU inside the FHM unit (420) related to downlink data.

FIG. 7 is a diagram illustrating a structure and each RU inside the FHM unit (420) related to an uplink message.

FIG. 8 is a flowchart illustrating a wireless equipment control method according to another embodiment of the present disclosure.

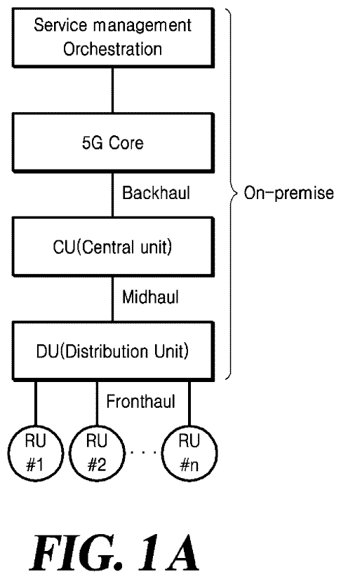

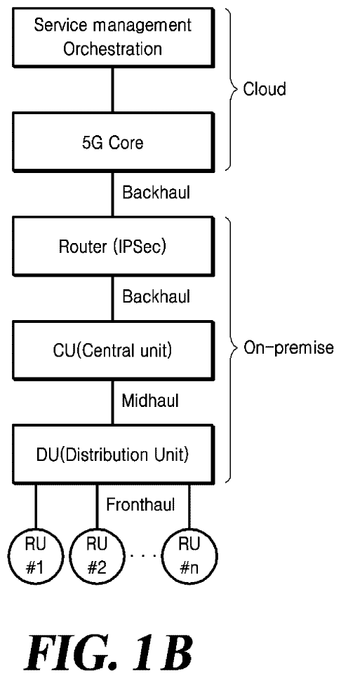

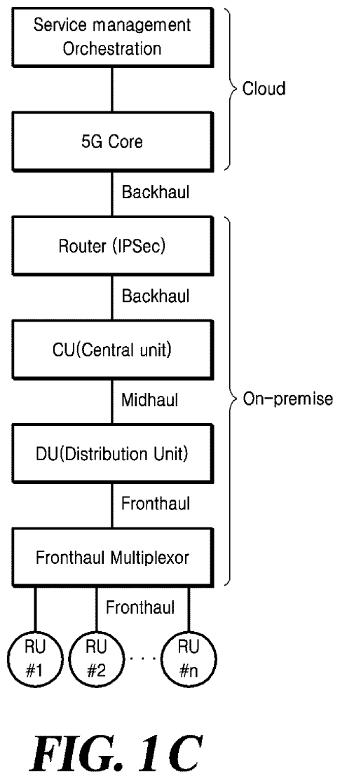

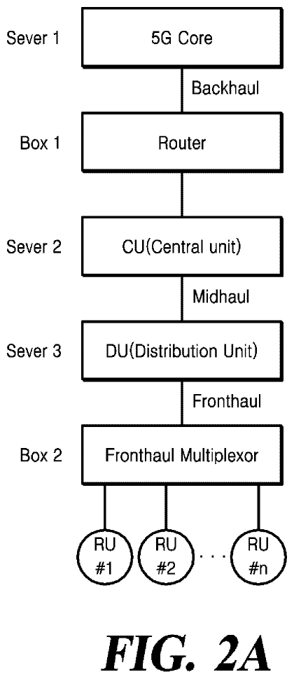

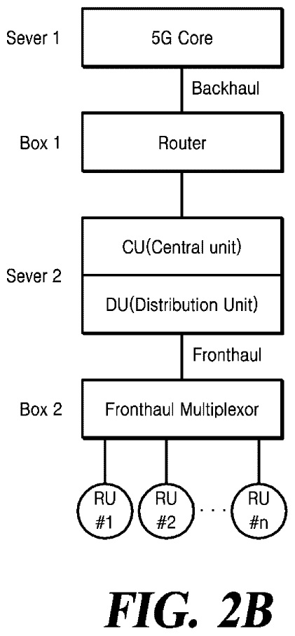

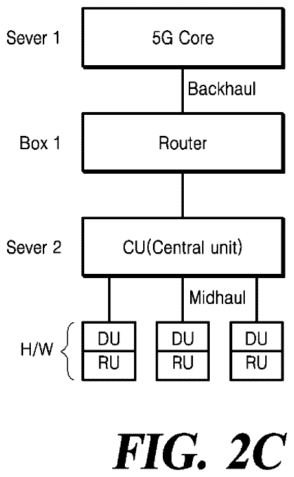

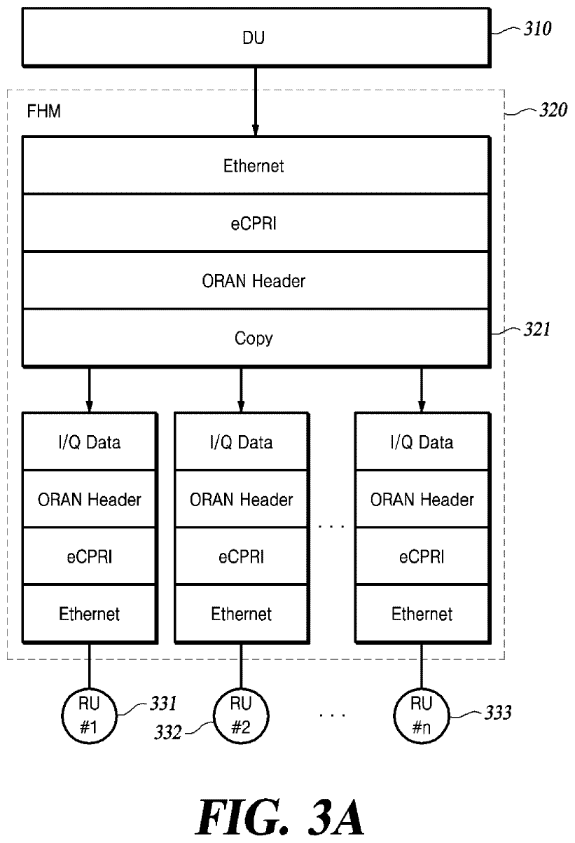

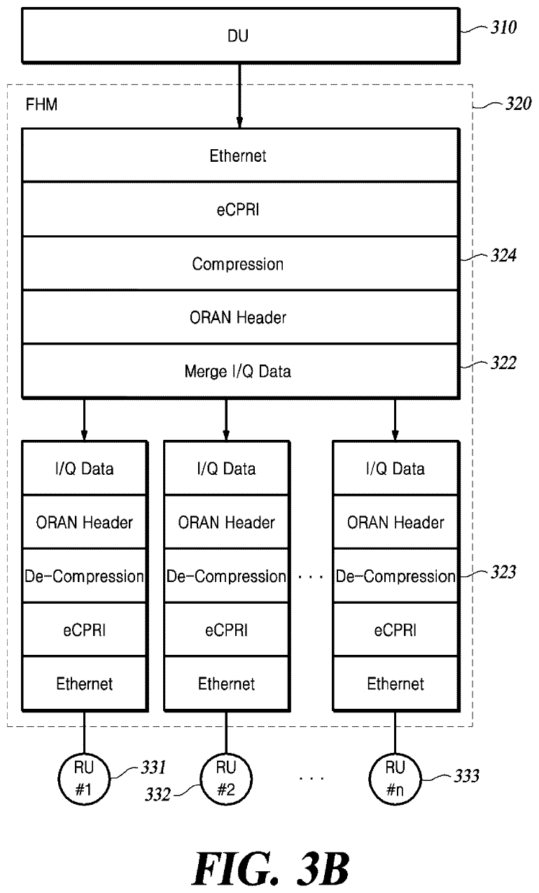

### DESCRIPTION OF THE PREFERRED EMBODIMENTS OF THE INVENTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

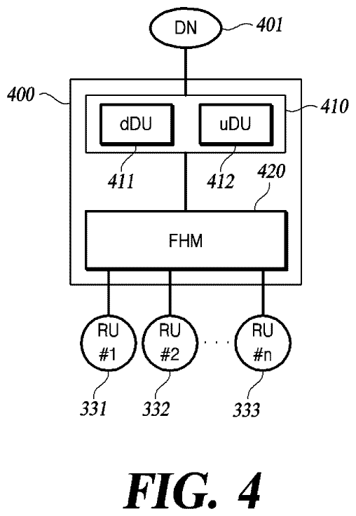

FIG. 4 is a block diagram illustrating a configuration of a wireless equipment control apparatus (400) according to one embodiment of the present disclosure.

As illustrated in FIG. 4, the wireless equipment control apparatus (400) according to the present embodiment may be implemented by providing a downlink Distribution Unit (dDU: 411), an uplink Distribution Unit (uDU: 412), and a Fronthaul Multiplexer Unit (FHM, 420). The wireless equipment control apparatus (400) according to the present embodiment may be implemented by omitting some of components in FIG. 4, or may be implemented by adding other components not illustrated in FIG. 4.

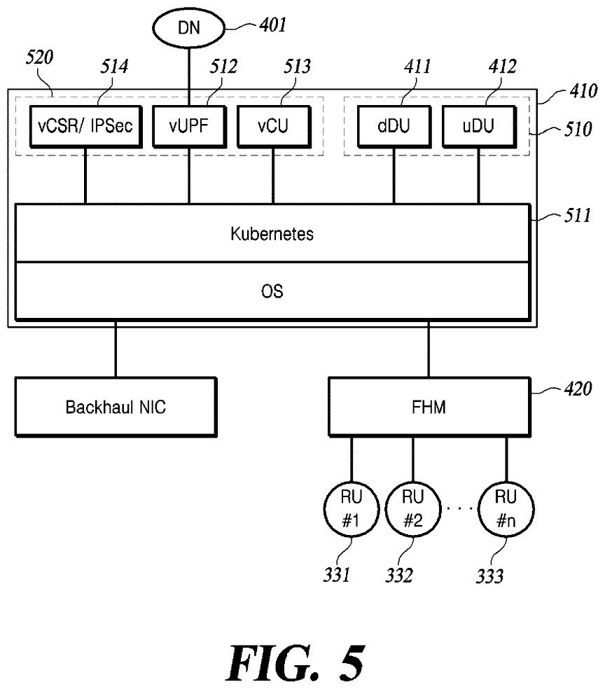

FIG. 5 is a diagram illustrating a state where the downlink DU (411) and the uplink DU (412) are implemented on a wireless network device (410) and the FHM unit (420) is connected to the wireless network device (410).

Hereinafter, the wireless equipment control apparatus (400) according to the embodiment of the present disclosure will be described with reference to FIGS. 4 and 5 together.

As illustrated in FIG. 5, the downlink DU (411) and the uplink DU (412) are implemented on the wireless network device (410).

The wireless network device (410) is connected between a wireless network (401) and at least one RU (331, 332, 333), and fulfills a function of receiving, processing, and transmitting data between the wireless network (401) and at least one RU (331, 332, 333).

The downlink DU (411) and the uplink DU (412) may be implemented to be operated on a Kubernetes platform (511) inside the wireless network device (410). The Kubernetes platform (511) is a container orchestration platform, and efficiently deploys, scales, and manages containerized applications.

An example has been described in which the wireless network device (410) is implemented by using the Kubernetes platform (511). Meanwhile, the present disclosure is not limited thereto, and may be implemented by using various virtualization platforms.

In addition to the downlink DU (411) and the uplink DU (412), a virtual User Plane Function (vUPF, 512), a virtual Central Unit (vCU, 513), and a virtual Certificate Signing Request/Internet Protocol Security (vCSR/IPSec, 514) may be implemented to be operated on the Kubernetes platform (511).

The vUPF (512) and the vCU (513) are implemented by virtualizing each of a User Plane Function (UPF) and a Central Unit (CU) function of a 5G network.

In addition, the vCSR/IPSec (514) is implemented by virtualizing each of a Certificate Signing Request/Internet Protocol Security (CSR/IPSec) function of the 5G network.

The vUPF (512) fulfills various functions such as routing of user data, QoS management, traffic management, charging, IP address management, and policy enforcement in the 5G network.

The vCU (513) has functions such as an interface with a user, efficient management of wireless resources, and setting up a data path.

The vCSR/IPSec (514) is a data block generated to request a digital certificate from a public Certification Authority (CA), and performs a verification before the certificate is issued. An IPSec fulfills a function of ensuring confidentiality and preventing data tampering by encrypting a downlink data packet or an uplink data packet on a network layer.

The downlink DU (411), the uplink DU (412), and the vUPF (512), the vCU (513) may exchange data with each other by using the Kubernetes platform (511).

A function of the downlink DU (411) and a function of the uplink DU (412) may be implemented as a function of a single virtual Distribution Unit (vDU, 510).

The downlink DU (411) receives downlink data, first control data, and RU group identification information from a network function (520).

The network function (520) that transmits the downlink data, the first control data, and the RU group identification information to the downlink DU (411) may be the vUPF (512), the vCU (513), or the vCSR/IPSec (514), but the present disclosure is not limited thereto.

Here, the downlink data includes user data, and the user data may include user content such as voice, video, text, image, and file transfer.

The first control data includes resource allocation information, scheduling information, and network configuration information.

Here, the resource allocation information includes allocation and management information of wireless resources, and is used to control a frequency, a time, and a space resource.

The scheduling information means information for determining a timing and priority of user data transmission.

The RU group identification information is information for identifying one RU group to which the downlink data is transmitted. The one RU group includes at least one RU (331, 332, 333).

The downlink DU (411) converts the downlink data into first IQ data, compresses the first IQ data, and generates first compressed IQ data. Here, the first IQ data means that the downlink data serving as a wireless analog signal is expressed in a digital form.

In addition, the downlink DU (411) generates a first ORAN header including the RU group identification information, and transmits a first message including the first compressed IQ data and the first ORAN header to the corresponding FHM unit (420).

The wireless network device (410) is provided with a plurality of Peripheral Component Interconnect Express (PCIe) interfaces, and the FHM unit (420) is connected to each of the PCIe interfaces.

At least one RU group is connected to each FHM unit (420).

The downlink DU (411) stores information on the plurality of FHM units (that is, a plurality of FHM information), and each FHM information includes information on a RU group connected to the corresponding FHM unit (that is, RU group identification information).

The FHM unit (420) may be implemented as a network interface card having the FHM function, and may be implemented to be connected to the wireless network device (410) with the PCIe interface. Here, the FHM function means a function of copying the first compressed IQ data and transmitting each first compressed IQ data to at least one RU (331, 332, 333) included in an RU group corresponding to the RU group identification information.

The FHM unit (420) may be provided with a plurality of Ethernet ports, and each of the RUs (331, 332, 333) may be connected to each of the Ethernet ports provided in the FHM unit (420).

The downlink DU (411) acquires FHM information corresponding to the RU group identification information by referring to the stored FHM information, and identifies one FHM unit (420) corresponding to the acquired FHM information from the plurality of FHM units.

The downlink DU (411) transmits the first message including the first compressed IQ data to the one identified FHM unit (420). The downlink DU (411) transmits the first message including the first compressed IQ data and a DMA write command to the corresponding FHM unit (420).

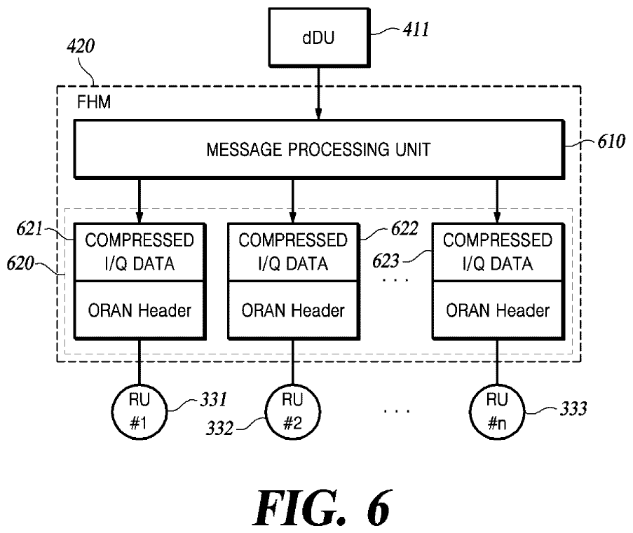

FIG. 6 is a diagram illustrating a structure and each RU inside the FHM unit (420) related to the downlink data.

As illustrated in FIG. 6, the FHM unit (420) includes a message processing unit (610) and a memory unit (620).

The memory unit (620) includes memories (621, 622, 623) corresponding to the respective RUs (331, 332, 333).

The message processing unit (610) acquires the RU group identification information from the first message received from the downlink DU (411), and writes the first message to the memory corresponding to the acquired RU group identification information. That is, the message processing unit (610) copies the first message, and writes the copied first message to each of the memories (621, 622, 623) corresponding to at least one RU (331, 332, 333) corresponding to the RU group identification information.

The message processing unit (610) stores memory identification information for identifying each of the memories (621, 622, 623) corresponding to at least one RU (331, 332, 333) corresponding to the RU group identification information.

The FHM unit (420) is provided with a plurality of Ethernet ports for connecting at least one RU (331, 332, 333) in a wired manner.

Immediately after writing the copied first message to each identified memory (621, 622, 623), the message processing unit (610) transmits the copied first message to the corresponding RU (331, 332, 333).

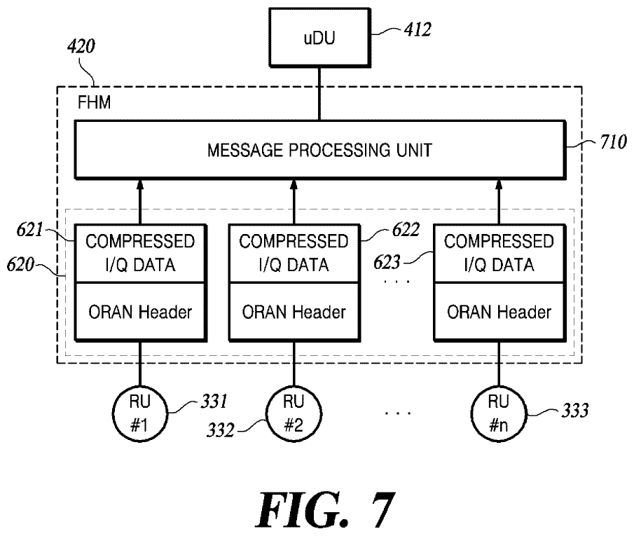

FIG. 7 is a diagram illustrating a structure and each RU inside the FHM unit (420) related to an uplink message.

As illustrated in FIG. 7, the FHM unit (420) includes a message merging unit (710).

The FHM unit (420) receives each second message including each second compressed IQ data and each second ORAN header from at least one RU (331, 332, 333), and stores the second message in each of the memories (621, 622, 623).

The message merging unit (710) decompresses the second compressed IQ data in each of the second messages, generates second original IQ data, merges each second original IQ data, generates merged IQ data, and transmits the merged IQ data to the uplink DU (412). Here, the merging may mean calculating an arithmetic sum for mutually different IQ data or calculating a weighted sum obtained by applying each weighted value to each of the mutually different IQ data.

The uplink DU (412) transmits a DMA read command to the FHM unit (420), and acquires a merged message including the merged IQ data from the FHM unit. Here, the DMA read command includes the RU group identification information.

The message merging unit (710) acquires the RU group identification information from the DMA read command received from the uplink DU (412), acquires each second compressed IQ data from the memories (621, 622, 623) corresponding to the RUs (331, 332, 333) of the RU group corresponding to the acquired RU group identification information, merges each of the second compressed IQ data, and generates one merged IQ data.

The message merging unit (710) transmits the merged message including the merged IQ data and the second ORAN header corresponding to each second compressed IQ data to the uplink DU (412).

The uplink DU (412) acquires the merged IQ data from the FHM unit (420), generates the uplink data from the merged IQ data, and transmits the uplink data to the network function (520).

Meanwhile, the message merging unit (710) may be implemented to generate the merged IQ data, based on each of the weighted values by assigning each weighted value to each second original IQ data.

The message merging unit (710) multiplies each of the weighted values for each of the second original IQ data to each of the second original IQ data, calculates each weighted data, merges each calculated weighted data, and generates the merged IQ data. That is, a weighted sum obtained by adding each of the weighted data to each other is the merged IQ data.

Meanwhile, the uplink DU (412) causes the DMA read command to include weighted value information, and transmits the DMA read command to the FHM unit (420). The FHM unit (420) acquires the weighted value information corresponding to each RU (331, 332, 333) from the DMA read command.

The uplink DU (412) estimates a channel state between each RU (331, 332, 333) and a terminal (not illustrated) wirelessly connected thereto by using a Channel State Information-Reference Signal (CSI-RS) or a Sounding Reference Signal (SRS), determines each weighted value, and transmits the determined weighted value to the FHM unit (420). Since estimating the channel state between each RU (331, 332, 333) and the terminal by using the CSI-RS or the SRS is beyond the scope of the present disclosure, detailed description thereof is omitted.

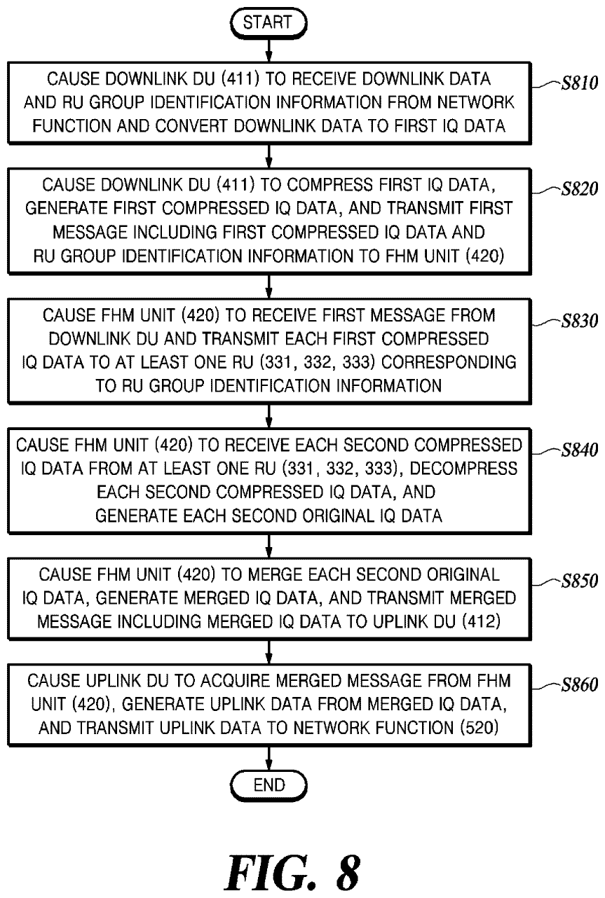

FIG. 8 is a flowchart illustrating a wireless equipment control method according to another embodiment of the present disclosure.

The wireless equipment control method according to the embodiment of the present disclosure may be achieved by the wireless equipment control apparatus (400).

The downlink DU (411) receives the downlink data and the RU group identification information from the network function (520), and converts the downlink data into the first IQ data (S810).

The downlink DU (411) compresses the first IQ data, generates the first compressed IQ data, and transmits the first message including the first compressed IQ data and the RU group identification information to the FHM unit (420) (S820).

The FHM unit (420) receives the first message from the downlink DU (411), and transmits each first compressed IQ data to at least one RU (331, 332, 333) corresponding to the RU group identification information (S830).

The FHM unit (420) receives each second compressed IQ data from at least one RU (331, 332, 333), decompresses each second compressed IQ data, and generates each second original IQ data (S840).

The FHM unit (420) merges each second original IQ data, generates the merged IQ data, and transmits the merged message including the merged IQ data to the uplink DU (412) (S850).

The uplink DU acquires the merged message from the FHM unit (420), generates the uplink data from the merged IQ data, and transmits the uplink data to the network function (520) (S860).

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. An apparatus for controlling wireless equipment, comprising:
a downlink DU that receives downlink data and RU group identification information from a network function, converts the downlink data into first IQ data, compresses the first IQ data, generates first compressed IQ data, and transmits a first message including the first compressed IQ data and the RU group identification information to an FHM unit;
the FHM unit that receives the first message from the downlink DU, transmits each of the first compressed IQ data to at least one RU corresponding to the RU group identification information, receives each second compressed IQ data from the at least one RU, decompresses each of the second compressed IQ data, generates each second original IQ data, merges each of the second original IQ data, generates merged IQ data, and transmits a merged message including the merged IQ data to an uplink DU; and
the uplink DU that acquires the merged message from the FHM unit, generates uplink data from the merged IQ data, and transmits the uplink data to the network function.

2. The apparatus for controlling wireless equipment of claim 1, wherein the FHM unit includes each memory area corresponding to each of the RUs, and the downlink DU transmits a write DMA command to the FHM unit to write the first message to each of the memory areas corresponding to the at least one RU.

3. The apparatus for controlling wireless equipment of claim 2, wherein the FHM unit includes a message processing unit that writes the first message to each of the memory areas corresponding to the at least one RU, and transmits each of the written first messages to the at least one RU.

4. The apparatus for controlling wireless equipment of claim 1, wherein the downlink DU stores information on a plurality of FHM units, and information on each FHM unit which is included in the information on the plurality of FHM units includes information on a RU group connected to the FHM unit.

5. The apparatus for controlling wireless equipment of claim 1, wherein the uplink DU transmits a read DMA command to the FHM unit, and acquires the merged message from the FHM unit.

6. The apparatus for controlling wireless equipment of claim 1, further comprising:
an interface including at least one connection port,
wherein the FHM is connected to the interface.

7. The apparatus for controlling wireless equipment of claim 6, wherein the FHM unit includes at least one wired port, and the at least one RU is each connected to the at least one wired port in a wired manner.

8. The apparatus for controlling wireless equipment of claim 1, wherein the FHM unit assigns each weighted value to each of the second original IQ data, and generates the merged IQ data in accordance with each of the weighted values.

9. A method for controlling wireless equipment in which an apparatus including a downlink DU, an FHM unit, and an uplink DU control wireless equipment, the method comprising:
a process in which the downlink DU receives downlink data and RU group identification information from a network function, converts the downlink data into first IQ data, compresses the first IQ data, generates first compressed IQ data, and transmits a first message including the first compressed IQ data and the RU group identification information to the FHM unit;
a process in which the FHM unit receives the first message from the downlink DU, transmits each of the first compressed IQ data to at least one RU corresponding to the RU group identification information, receives each second compressed IQ data from the at least one RU, decompresses each of the second compressed IQ data, generates each second original IQ data, merges each of the second original IQ data, generates merged IQ data, and transmits a merged message including the merged IQ data to the uplink DU; and
a process in which the uplink DU acquires the merged message from the FHM unit, generates uplink data from the merged IQ data, and transmits the uplink data to the network function.
